(19) United States
(12) Patent Application Publication
(10) Pub. No.: US 2013/0052598 A1
(43) Pub. Date: Feb. 28, 2013

(54) METHOD OF HIGH ENERGY PHOTON PRODUCTION

(71) Applicant: Donald I. GONSER, Mechanicsburg, PA (US)

(72) Inventor: Donald I. GONSER, Mechanicsburg, PA (US)

(21) Appl. No.: 13/434,967

(22) Filed: Mar. 30, 2012

Related U.S. Application Data
(60) Provisional application No. 61/526,338, filed on Aug. 23, 2011.

(51) Int. Cl. F27D 3/00; H05B 7/18

(52) U.S. Cl. 432/29; 432/120; 373/60

(57) ABSTRACT

A high energy photon production system and method which comprises a reaction vessel, a base heating source capable of generating a temperature of at least 4,000° F. within the reaction vessel; and a source of water for supplying water to the base heating source, within the vessel. As soon as the water is heated to a temperature of at least 4,000° F., at least some of the water becomes disassociated and facilitates production and release of high energy photons within the vessel which can be combined with the base heating source.

This application is a non-provisional application of and claims priority from U.S. Patent Application Ser. No. 61/526,338 filed on Aug. 23, 2011.

### FIELD OF THE INVENTION

The present invention relates to a method of producing high energy photons from hydrogen and oxygen atoms which may then be used in combination with another heat source to supplement the other heat source and maximize the resulting energy output.

### BACKGROUND OF THE INVENTION

The potential that relates to applications pertaining to the Photon Production System is virtually unlimited, such as, firing burners, to make steam from the Photon Production System process which, in turn, makes steam to run a steam turbine and generate electrical power. Such Photon Production System can provide energy for powering moving objects, such as, automobiles, trains, trucks, airplanes or any other moving device or apparatus with an engine or a turbine for powering such apparatus or device since it can be made portable. The Photon Production System is applicable to any stationary device or apparatus that requires an engine or turbine, such as backup generator, a stationary pump, a refrigeration unit, a burner, an incinerator, etc., including any other powered stationary equipment application utilizing an engine or a turbine as a source of power. Furthermore, the Photon Production System is also applicable to a variety of home or commercial heating and/or air conditioning applications or the like. Refrigeration and other stationary devices or equipment may also be incorporated into moving equipment and vehicles, such as, a truck or an airplane, but, as stated earlier in this description, the above are only a few of the many possible examples.

There are many industrial applications where a clean, or at least a cleaner, energy source is desired or required and the Photon Production System could be applied and used for such application, e.g., in either an industrial, a commercial or a home application. The elimination, or substantial complete elimination, of carbon and/or nitrogen based pollutants and the production of an efficient energy source is greatly needed today in a variety of industrial, commercial and home applications. An low cost energy source is also an important consideration and the Photon Production System is an low cost energy system which generally uses and consumes water in addition to the underlying base heating source.

### SUMMARY OF THE INVENTION

The following is a summary of a new and novel Photon Production System. The Photon Production System is different from a variety of other energy systems that are currently available today, and these currently known and existing systems are sometimes referred to as a “Clean Energy System”. It is to be appreciated that a clean energy system, is defined as its energy output that produces insignificant (i.e., very low quantities) hazardous gases or pollutants, or where the process can generate only a very small amount of carbon dioxide and/or other undesired gases. The preferred Photon Production System is truly a Clean Energy System because, except for the generation of O₂ and H₂ gases, it does not produce any carbon or nitrogen based gases, or other harmful gases, as its combustion byproducts. Some variations of the Photon Production System may produce only low amounts of pollutant gases (i.e., low quantities) when compared to other known energy systems. The explanation and description pertaining to the new and novel Photon Production System, according to the present invention, will become more apparent from the following description which further describes the underlying principles and processes of the Photon Production System.

Wherefore, it is an object of the present invention to overcome the above mentioned shortcomings and drawbacks associated with the prior art energy systems.

Another object of the present invention is to provide a base energy source that consists of the base heating source to which the generated photon energy is supplemented or added to and from which the combined total amount energy is increased by the amount of photon energy that is made available and added to the base heating source. It is to be appreciated that the amount of the added photon energy is determined by the photon's wavelength where the shorter the wavelength of the photon energy, the greater the amount of added energy to the base heating source. Accordingly, the amount of energy added to the base heating source is proportional to the wavelength of the photon multiplied by the number of photons added to the base heating source during this unique energy producing process.

The present invention also relates to a method of producing high energy photons including the steps of arranging two streams of combustible fuel to flow directly toward one another so as to converged, mix and interact with another; igniting the two streams of converging combustible fuel; arranging at least one, and more preferably two, streams of water to flow toward one another and directly into the interface of the two converging streams of combustible fuel, where the stream or streams of water will converged with one another at approximately in the common location of that the two streams of combustible fuel converged with one another, which is typically the hottest combustion zone or area of the converging two streams of combustible fuel.

The present invention also further relates to a high energy photon production system comprising water, a base heating source which interacts with and heats a portion of the water to at least 3,992° F. (2,200° C.), and more preferably heats the water to at least 5,422° F. (3,000° C.) and most preferably to heats the water to at least 7,000° F. (3,871.1° C.) to produce high energy photons, and a reaction vessel which aids in directing the flow of high energy photons.

The important features of the two step process pertains to the temperature reached and the percentage of the covalent bonds of the water that are intimately broken and are listed below:

(1) In theory, at room temperature (i.e., between 70° F. and 100° F.) the covalent bond of approximately only one water molecule out of about 100 trillion water molecules breaks, therefore, room temperature is not a very useful temperature for producing photon energy by use of the proposed process/method.

(2) At a temperature of approximately 3,992° F. (2,200° C.), approximately 3.0% of the covalent bonds of a given sample of the water molecules are broken. This temperature is generally regarded by the Inventor as the lower threshold temperature for breaking the covalent bonds of the water molecules, as demonstrated by the Inventor, and producing photon energy.

(3) At a temperature of approximately 5,422° F. (3,000° C.), approximately 50.0% of the covalent bonds of a given sample of water molecules are broken. Naturally, this temperature is better than 4000° F. at more efficiently breaking the covalent bonds of the water molecules, but for greater efficiency, a still higher temperature is desired.

At a temperature of approximately 7,000° F. (3871.1° C.) or higher, essentially 100.0% of the covalent bonds of a given sample of the water are broken. While temperatures at or above 7,000° F. offer the greatest percentage of breaking the covalent bonds of the water molecules, it is to be appreciated that such elevated temperatures has a tendency to present other problems. Such problems include limitations of materials which are readily capable of withstanding such operating temperatures for long durations of time, and the proper configuration of an enclosure for accommodate the various system components for practicing the present invention.

### BRIEF DESCRIPTION OF THE DRAWINGS

The invention will now be described, by way of example, with reference to the accompanying drawings in which:

FIG. 1 is a schematic representation of a first embodiment of a Photon Production System according to the present invention;

FIG. 2 is a schematic representation of a second embodiment of a Photon Production System according to the present invention; and

FIG. 3 is a schematic representation of a third embodiment of a Photon Production System according to the present invention.

### DETAILED DESCRIPTION OF THE INVENTION

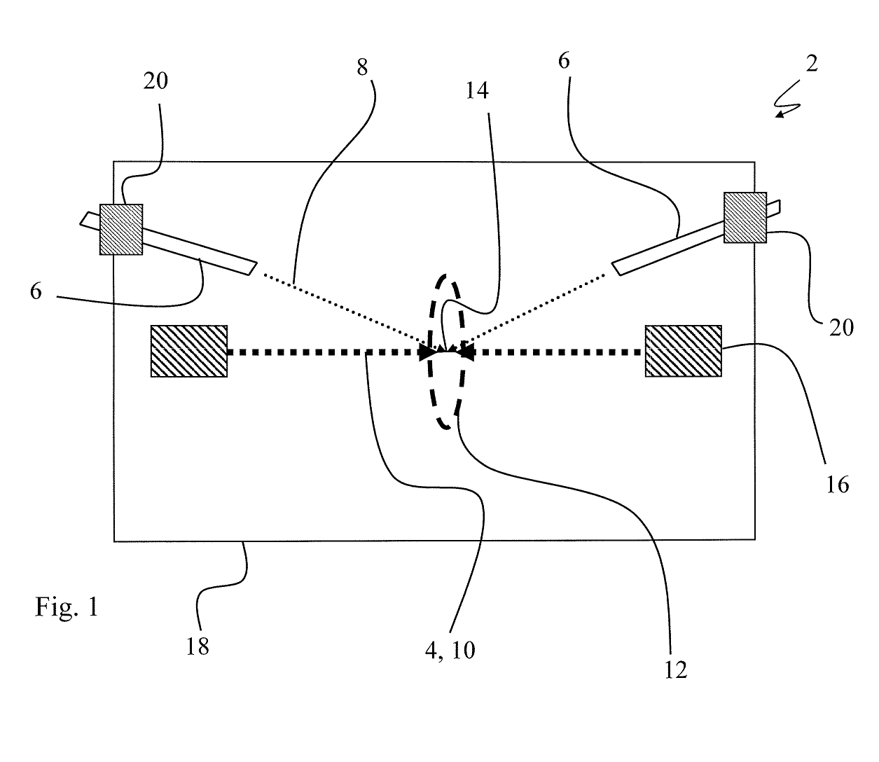

Turning now to FIG. 1, a brief description concerning the various components of the present invention will now be briefly discussed. As can be seen in this first embodiment, the Photon Production System 2 comprises a base heating source 4 and a water delivery element 6 that delivers water 8 at a desired and controllable flow rate to the base heating source 4. In the first embodiment, the base heating source 4 has two combustible gas flames 10 arranged opposite to and facing one another so that a centrally located flame disc 12 is formed where the two flames meet and interact with one another. The water delivery element 6, according to the first embodiment, comprises two syringes arranged substantially opposite to and also substantially facing one another, with their water streams directed to intersect with one another at an intersection area 14 that coincides with the location of the flame disc 12. Preferably, two directable gas nozzles 16 are used to deliver the desired supply of the combustible gas to fuel the flames 10.

The base heating source 4 and the water 8 ejected from the water delivery element 6 are all enclosed or otherwise encapsulated within a reaction enclosure or vessel 18 which controls the flow of gases into or out of the reaction area. The reaction vessel 18 may be vented, entirely closed, or have one or more controlled openings therein, depending upon the particular application.

The water delivery element 6 may include one or more pre-base heaters 20 that heat the water 8 to a desired temperature before the water 8 exits the water delivery element 6 and interacts with the base heating source 4 at the flame disc 12. The pre-base heaters 20 may include the same types of elements as the base heating sources 4, and may be the same method of as used for the base heating source 4 or possibly a different method. The pre-base heaters 20 may be located inside the reaction vessel 18, may overlap the border of the reaction vessel 18, or the pre-base heaters 20 may pre-heat the water 8 in the water delivery elements 6 before the water delivery elements 6 enter the reaction vessels 18.

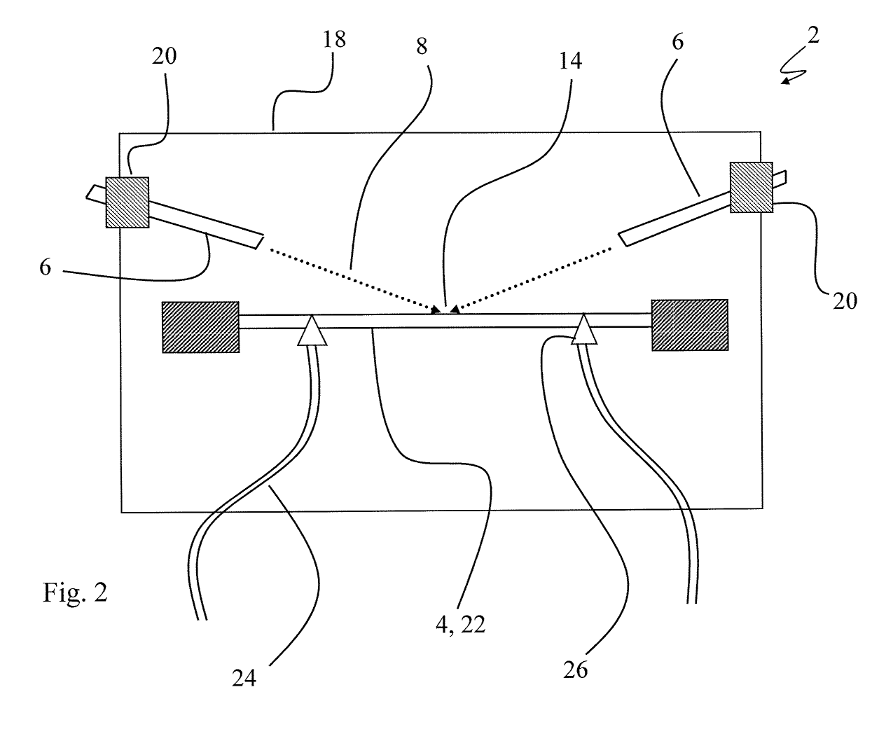

Turning now to FIG. 2, a second embodiment of the present invention will now briefly discussed. As shown in this Figure, the second embodiment of the Photon Production System 2 utilizes a metal filament 22, preferably made of tungsten or some other suitable material which is able to withstand high temperatures (e.g., temperatures ranging from 3,992° F. (2,200° C.) to 7,000° F. (3871.1° C.)), as the base heating source 4. Electric wires 24 with clamping nodes 26 provide an electrical current which flows along the filament 22 during operation of the system.

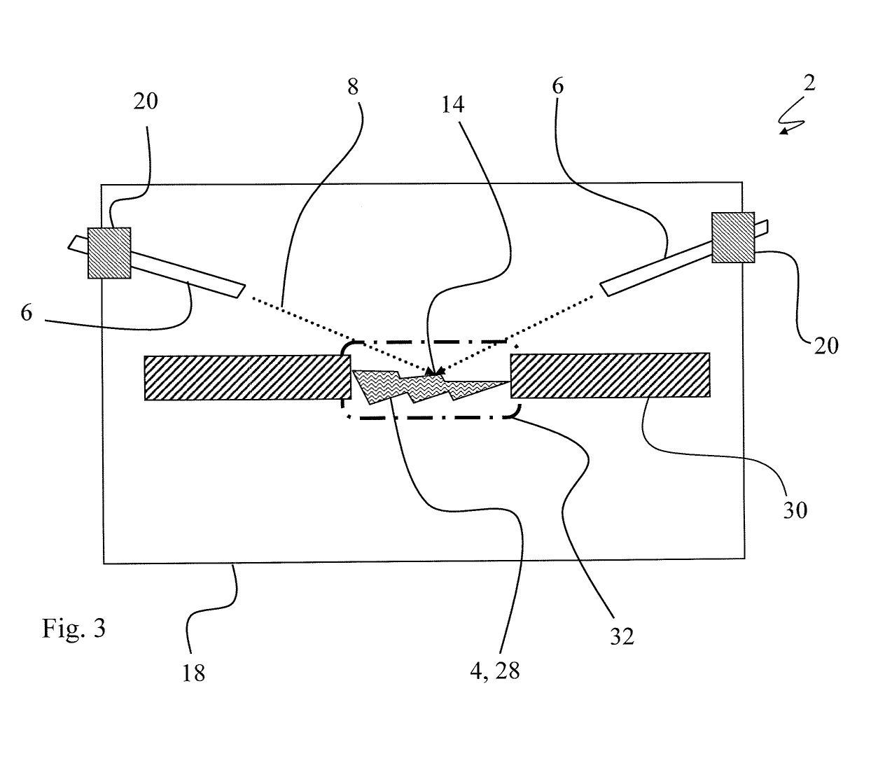

Turning now to FIG. 3, a third embodiment of the present invention will now be briefly discussed. As can be seen in this Figure, the third embodiment of the Photon Production System utilizes an electric arc 28, as the base heating source 4, which is generated and arcs between the end faces of two adjacent and facing electrodes 30. A noble gas envelope 32 may be used to isolate the area of intersection 14 from other gases.

It is to be appreciated that for all embodiments discussed above, it is generally desirable for the reaction vessel 18 to be evacuated so as to remove all air before commencing operation of the process.

General Process

The terminology that is used today and often referred to publically as “burning water 8”. Each molecule of water 8 must first be dissociated from its molecular form into its elemental atomic form. When this occurs, the dissociated water 8 comprises two hydrogen (H) atoms and one oxygen (O) atom such that the elements of the disassociated water 8 can enter into an energy contribution process. For example, when the hydrogen is rendered free and in a heated state, its electron shell is forced into a higher orbit and, upon the hydrogen atom cooling down, the electron returns back to its more stable lower orbit and releases energy in the form of a high energy photon. This high energy photon has a short wavelength, e.g., typically about 128 nm wavelength and is in the ultraviolet region of the electromagnetic spectrum. Each one of these additional photons from hydrogen and oxygen atoms can, thereafter, directly contribute and supplement the conventional base heating source 4.

Water splitting, which moderated by temperature, splits the water's polar covalent bonds to release the atoms of hydrogen and oxygen. The breaking of the polar covalent bonds of the water 8 gradually becomes more efficient as temperature of the water is increased from a temperature of about 4,000° F. up to a temperature of about 7,000° F., or so. For example, at 3,992° F. (2,200° C.) only about 3 percent of all water (H₂O) is dissociated into various combinations of H, H₂, O, O₂ and OH. Other reaction products are possible, such as H₂O₂ or HO₂, only generally comprise a minor portion of the dissociated byproducts.

If the disassociation temperature of the water is increased to 5,432° F. (3,000° C.), then about 50 percent of the molecules of water 8 are dissociated into their atomic form. Finally, if the disassociation temperature of the water is increased to 7,000° F. (3871.1° C.), then about 100 percent of the H₂O polar covalent bonds of the water are broken. This compares to the dissociation of water 8 at normal ambient temperatures (between 70 and 100° F.) where only about one (1) in 100 trillion molecules of water 8 dissociates and this marked difference is generally due to the effect of heat (temperature). The release of hydrogen and oxygen (to their atomic form) from each molecule of water 8 is only one step in the process.

The molecule of water 8, rapidly heated (within a few milliseconds to at least 4,000° F.), requires necessary energy to excite the molecule of water 8 and raise the electron(s) of the molecules/atoms to a higher quantum level, sometimes referred to as an electron orbit. This process not only results in breaking the polar covalent bonds of water 8, it also has its atoms and their electrons at a sufficiently high orbit level, due to the high temperature, to store and release the atoms' photon energy, which takes place, as the atoms cool down. Since both sequential processes take place essentially at the same time, the process, as described herein, can be rightfully defined as a dynamic two step process (i.e., that appear to occur substantially at the same time).

Once the atom's photon energy is released, which occurs very soon after the electron raises to a higher quantum state (and takes place upon cool down of the atoms), the photon energy is produced and is added directly to the base energy heat source. Finally, most of the gases (atoms) after cool down generally naturally recombine back into molecules of water 8 while only a small percentage of the atoms that do not recombine into molecules of water 8, may escape into the atmosphere as gases of hydrogen and oxygen (e.g., H, H₂, O, O₂).

As noted above, each atom normally produces one photon of energy. In fact, two photons can be produced in an extremely excited state of an atom, e.g., during ionization, but the Photon Production System energy process normally produces only one photon per atom. A photon is a desecrate bundle of energy which has no mass. The first phase of the process is to break the covalent bonds that exist between the oxygen atom and each hydrogen atom of the water molecule. This is necessary in order to free-up the two hydrogen atoms and the single oxygen atom. If this first phase of the Photon Production System process is not accomplished (i.e., the breaking of covalent bonds), then the photon energy bundles will not be released, as desired, from the molecule of water 8. It is necessary to first break the strong covalent bonds of water 8 in order to reduce the water 8 into its constituents' atomic state, then the photon energy bundles can be more readily be made available from the elemental atoms that initially formed the water 8. The covalent bonds of the water 8 can be broken through the process of violent agitation, where heating of the water 8 to at least about 4,000° F. so as to achieve such violent agitation. This process occurs when very high heat is applied to the water 8 and the applied heat rapidly raises the temperature of the water 8.

The second and final phase of the Photon Production System energy process pertains to the fact that energy input must occur in order to raise the water 8 temperature to the point where the covalent bonds of the water 8 are broken and where this same input heat energy has raised the electron orbits of the atoms of the water 8 to a higher state above the ground state of the electron. When each atom cools down, its electron jumps toward the ground state, and a photon bundle of energy is released. The photonic energy is then added directly to and supplements the base heating source 4 so that the resulting combined total energy is generally increased by the amount of added photonic energy added to the base heating source 4. Also, upon cooling down below a temperature of around 4,000° F., for example, the hydrogen and the oxygen gases/atoms can then readily recombine with one another back into water 8 and thereby release additional energy.

It is to be appreciated that since the hydrogen and the oxygen are both gases, it is conceivable that a portion of the hydrogen and the oxygen gases may possibly escape from the reaction vessels 18 before being able to recombining back into water 8. The physical design of the system can help to eliminate the undesired escape of the hydrogen and the oxygen gases/atoms from the system. Again, as stated above, it is to be borne in mind that a huge amount of photonic energy is contained within a small drop of water 8.

Gas Combustion Base Heating

There are a range of heating sources, such as the combustion of a gas or gases, that are capable of producing a flame 10 having a temperature higher than 4,000° F. In addition, an electrical arc 28 plasma can produce a temperature of 4,700° F. or higher, a laser can produce temperatures much higher than 4,000° F., and/or a radio frequency induction or capacitive heating can also produce a temperature greater than 4,000° F. An important aspect is that the one or more of such energy sources, must heat the molecules of water 8 to a temperature of at least approximately 4,000° F. (2,204.4° C.) which is a temperature that is generally sufficient to break a sufficient amount of the covalent bonds of the molecules of water 8. It is to be appreciated that temperatures greater than 4,000° F. can, of course, be used to break the covalent bonds of water 8 and such higher temperatures are generally desirable for more efficient disassociation of the water.

If a lower temperature flame 10 is applied (e.g., a flame 10 having a temperature of only about 3,596° F. resulting from the combustion of propane and air, a flame 10 having a temperature of about 3,542° F. resulting from the combustion of methane and air, or a flame 10 having a temperature of about 3,562° F. resulting from the combustion of natural gas), then it is to be appreciated that the available heat, at such lower temperatures, has a tendency to insufficiently thermally stress the covalent bonds enough to dissociate a significant amount of the molecules of water 8 into their atomic state, where such dissociated water 8 can then be used as a photon energy source to be added to the base heating source 4, in accordance with the teachings of the present invention.

It is to be appreciated that any available base heating source 4, or combination of base heating sources 4, can be employed to heat the molecules of water 8 to a temperature of at least approximately 4,000° F., or greater, in order to assist with substantially completely dissociating all of the molecules of water 8 into their elemental atomic parts, where the photonic energy that is produced can then be utilized to supplement the base heating source 4 and thereby result in an improved energy source.

Tests performed by the Inventor confirm that by using a temperature of greater than 4,000° F. consistently and reliably dissociates a substantial portion of the molecules of water 8 into their elemental atomic parts and consequently creates the desired photonic energy that can be used to supplement the base heating source 4.

Experimental work with various gases, as a heating source, demonstrate there are some problems due to the high exit speed of the gases, which is approximately delivered at a supply rate of about 12 feet per second. This relatively high supply rate of the gas renders it somewhat difficult to introduce the water 8 precisely into the hottest region or area of the flame 10 (generally the area of the flame disc 12 where the two streams converge and/or intermixed with one another), which is generally necessary in order for the water 8 to disassociate efficiently. As a consequence, a relatively small amount of water 8 is actually supplied to the hottest zone or area of the flame 10, which makes this method somewhat inefficient. However, using a heated filament 22, as a heat source (see FIG. 2 for example), avoids the gas flow rate problem presented by the gas flow combustion method. Of course, combinations of a filament 22 heater element, a gas undergoing combustion, and water 8 can be used to amplify or compliment the net or combined temperature that is ultimately attained.

It will be noted that when two streams of water 8 are combined with two streams of the ignited and combustible material, there is visible flame 10 growth which is believed to be directly due to the increase in the released photons and the associated increase in energy added or supplemented to the base heating source 4.

Using only hydrogen and feeding the hydrogen gas to the base heating source 4, to raise the hydrogen electron orbit level, was contemplated by the Inventor. However, one problem with this approach is that self ignition (the auto-ignition temperature) of hydrogen is generally reached at a temperature of only 997° F., and this temperature generally destabilizes the process. When water 8 is utilized in the process, there is no self ignition point as a molecule; and when a temperature above 4,000° F. is reached, the covalent bonds tend to be more readily broken thereby generating atoms of hydrogen and oxygen. At that temperature above 4,000° F., the atoms tend to have their electrons raised to a high orbit which will produce a photon of energy and this occurs during cool down, thus satisfying the process.

Experimentation by the Inventor to date is providing a better and a more complete understanding of the problems relating to the efficiency aspect of heating the water 8 rapidly to a temperature of at least 4,000° F. (within a time span of only a few milliseconds). The use of a flame or two or more flames 10 to heat water 8 rapidly, by direct injection, to a temperature of at least 4,000 F is apparently a less effective method for efficient heating of water 8 because such process prevents rapid heating of water 8 conditions that tend to work against the heat transfer and the delivery mechanism up to the required temperature limits in this process. As stated earlier above, a single drop of water 8 contains a tremendous amount of potential photon energy which only can take place if substantially the entire drop, containing the molecules of water 8, is rapidly heated to at least 4,000° F. It was determined with the application of two opposing flames 10, where two water 8 drops, delivered directly into each gas flame 10 (HHO gas/Browns gas) results in a very small percentage of the water drops being heated to at least 4,000° F. Most of the water drops remain as slightly smaller drops of water 8 where the remaining drops are jettisoned out of the flame 10 and away from the hottest portion of the flame 10, thus, generally preventing the remaining water 8 drops from being heated to at least 4,000° F., via the base heat source 4. As noted above, the percent of water 8 polar covalent bonds that can be readily broken and the amount of atomic photon energy that is, in turn, made available is dependent upon the temperature to which the water 8 is heated.

There are challenges with using direct injection of water 8 into a flame 10 or a pair of flames 10 used as a water 8 heat up source. When the water 8 comes in physical contact with the combustion flame, the injected water 8 has a tendency to interfere with the efficiency of this type of base heat source 4. These challenges are identified and listed below.

It is to be appreciated that a flames 10, from a standard torch, inherently tends to be unstable, thus reducing the average efficiency by causing non uniform temperatures (resulting in lowering the average temperature of the water 8) which results in a decrease or reduction in the breaking of the polar covalent bonds of water 8 directly injected into the gas flame(s) 10. When this method is used, as a means for a water base heat source 4, the temperature reached depends on the efficiency of the combustion process and the gases used for combustion. The temperature reached, varies in the flame(s) 10 and it, therefore, functions to deliver a temperature gradient (typically the flame 10 is hotter on the inside and cooler on the near and/or outside of the flame 10).

The presence of water 8 in the flame 10 can significantly interfere with normal combustion, therefore, it is questionable that the temperature uniformity of normal combustion is maintained in the immediate vicinity of the water 8 drop. While water 8 remains in its molecular form (e.g., as H₂O —in either a liquid or a gaseous state) it will certainly interfere with the combustion process of the flame 10, even to the point where excessive water 8 may possible extinguish the flame 10 (total interference with the combustion process where up to 100% interference with the combustion process disrupts and/or stops the base heat up process altogether).

Flames 10 generally result from the combustion of gases and requires the gas flow rate to be maintained in order to develop a back pressure of the gasses being delivered to the torch tip or nozzles 16 which is necessary to be controlled in order to prevent flash back of the gases that must travel to the nozzle 16 from a storage or a supply source(s). Typically, the rate of gas flow from the nozzles 16 is approximately 12 feet/second. This is a relatively rapid nozzle gas flow rate which is required, as stated, to prevent flash back within the delivery means of the gas's source. Also, at the same time, the gases cause flame flow turbulence and gas type “eddy currents” which also inherently form adjacent to the high gas flow rate and also are inherently created by this process/method when used as a base heat source 4 for the water 8. The necessary fast gas flow rate also works against the introduction of a drop of water 8 which must receive the necessary rapid heat transfer in order to raise its temperature immediately to at least 4,000° F. and break both of the polar covalent bonds of the molecule of water 8.

For the most part, this necessary, rapid gas flow rate, process is not made to occur so as to improve the efficiently of the rapid heating process and increase production of photon energy output. It is only created, however, for safety reasons (i.e., it is created to prevent an explosive flash back which is a safety issue). That it is why the process of direct injection of water 8, into a base flame 10 having a temperature of at least 4,000° F., is considered a less desirable base heat source 4 for application of water as described herein. While direct injection of water 8 into the combustion of a gas flame(s) 10 is a method that is generally not the best base heat source 4 for generating photon energy, such method does falls within the scope of this application.

The water 8 must be heated rapidly because the weak hydrogen bonds, between molecules of water 8, break at 212° F. This results in the production of steam (which is where water 8 becomes a gas) and is also where the water (H₂O) molecules become widely separated (becomes 700 times less dense at sea level and at atmospheric pressure). As steam, the molecules of water 8 become a gas; therefore, the transfer of heat to water 8 must take place within a very short duration of time before the steam-gas escapes to a cooler heat up zone (as the water 8 becomes less dense in the form of steam), preferably within about 10 milliseconds. The temperature of at least 4,000° F. must be reached before the strong polar covalent bonds of the molecule of water 8 break, which then reduces the water molecule into its atomic state. The conditions presented by gas flames 10 are counter productive in rapidly heating of water 8 to at least 4,000° F. Therefore, the direct injection of water 8 into a gas-flame 10 process directly contributes to the inefficiency in producing photon (energy) from heating water 8 by this method. The problems pertaining to gas flames 10 and the direct injection of water 8 as a base heat up source were recognized, also the certain limitations relative to the rapid heating up of water 8 are presented by this method. This inefficiency was a problem which caused the evaluation of alternative ways to slow down or decrease the flow rate of the gas flames 10 (after the gas exits from the nozzle 16, for example). This is generally what lead the Inventor to the dual opposing flame 10 arrangement and method (see FIG. 1, for example). The opposing two flame 10 arrangement and method permit more of the applied water 8 drop(s) or droplet(s) to be heated to at least 4,000° F., when compared to the single flame 10 process. The opposing two flame 10 arrangement and method produced a greater amount of photon energy, which was added to and supplemented the base flame 10 and the overall size of the flame 10 size grew substantially compared to an experiment with only a single flame arrangement.

Both opposing flames 10, in which each of the two flames 10 are directed toward each one another and meet substantially “head on”, generally produce a disc shaped circular flame, or a flame disc 12, as diagrammatically shown in FIG. 1. The elongate axis of the flame disc 12 extends generally at a right angle (90°) to the flow of each of the two opposing flames 10.

At the interface where the flames 10 meet with one another, the velocity of the gas/flames 10 impacting one another is 2×12=24 feet/second and is created from the impact to each of the flames 10 that are traveling at each other from opposite directions. However, at the location where the flames impacts one another, from opposite directions, the flame speed at the interface or point of impact is slowed to approximately zero velocity. It appears that at the point of impact most of the gas/flames 10 vector off at approximately a right angle (90°) and thereby forms a circular flame disc 12 which is larger in diameter than the diameter of either of the two flames 10. A drop of water 8 introduced at each of the opposing nozzles 16 is rapidly transported to the flame disc 12 area and some of the water 8 drops are rapidly heated to a temperature of at least 4,000° F., thus resulting in photon flame growth from the heated hydrogen (2) atoms and oxygen (1) atom. It was also observed that some of the water 8 drops still fell from the opposing flames 10, during in this process, so it was obvious that both of the polar covalent bonds of all of the molecules of water 8, in the drop(s) of water, were not broken.

A disadvantage of the single flame 10, aside from the inefficiency of heating the water 8 to a temperature of at least 4,000° F., is that the added water 8 also tends to interfere with the flame combustion process and has a tendency to extinguish the single flame 10, whereas, the opposing two flame 10 arrangement and method has a tendency to maintain combustion of the flame. In addition, with the opposing two flame 10 arrangement, if one of the flames 10 becomes extinguished for some reason, then the extinguished flame is typically reignited by the other flame 10 and the process is largely uninterrupted or, at most, only momentarily interrupted.

As outlined in the above, the direct injection of water 8 into a gas flame(s) is not the most efficient process for raising the temperature of the water 8 to at least 4,000° F., such injection is generally more unstable, and may prove to be somewhat more expensive. Still other methods are believed to produce better results and yield more efficient heating of larger quantities of the water 8 to a temperature of at least 4,000° F. Also, other base heat sources 4 may provide greater efficiency over the direct injection of water 8, which is delivered directly into the single flame 10 or two or more flames 10, heating method, and possibly at a lower cost.

Other base heat source 4 technologies were explored in order to achieve improved heat up efficiency for breaking the polar covalent bonds of the water. First, as stressed above, the water 8 heat up apparatus or technique must be a clean heating source—without producing excessive, unacceptable amounts of undesired gases or other solid pollutants.

Other base heating sources 4, such as, an electrical arc 28 in air, or electrical arc 28 in a rare gas or a noble gas envelope 32, a heated filament 22 (i.e., tungsten wire, for example), a laser or a radio frequency plasma are all known sources which are capable of generating temperatures in excess of 4,000° F. and can serve, either alone or in combination with one another and/or other heating sources, as the base heating source 4. Also, one can utilize still other base heating sources 4 by using a combination of base heating sources 4, or a base heating source 4 that operates in stages, such as a preliminary or pre-base heating source 20 followed by the base primary heating source 4, i.e., a heating filament 22 followed by a gas flame 10, for example), which will be discussed below in further detail. The Photon Production System clean energy process can be accomplished by using a variety of heating sources and mechanisms which are capable of heating the water to a temperature of at least approximately 4,000° F., or more preferably to a temperature of greater than 4,000° F.

Metal Filament Heating

As noted above, a laser heating source, a gas type flame 10 or different types of gas flames 10 and/or the use of an electrical arc 28 heating source may be utilized for producing a temperature in excess of 4,000° F. Also, one can use a metal type filament 22, such as, tungsten, tantalum, and molybdunum, in order to generate temperatures of greater than 4,000° F., because all of these metals have melting temperatures which are greater than 4,000° F. Also, metal alloys, such as, silicon carbide, tungsten carbide and other alloys that have a melting point or temperature greater than 4,000° F. and would also be acceptable. A filament source, for heating water 8, provides a very stable source when compared to a gas type flame 10 heating source, for rapidly heating water 8 to at least 4,000° F. in order to reliably dissociate the water 8 and convert the supplied molecules of the water 8 into their elemental atomic state by breaking the covalent bonds and liberating the two hydrogen atoms and one oxygen atom from one another.

The Inventor conducted experiments with respect to a resistance heating method due to the fact that there is no basic turbulence when compared to the direct injection of water 8 into a gas flame(s) 10 heat up source. Also, with a resistance heating method, there is no combustion process which can interfere with the heating and/or the disassociation, as there is with the direct injection of water 8 into the flame(s) 10 heating method. Metal tungsten wire was chosen as the heating element mainly because of its high melting temperature of 6,170° F. Once the tungsten wire(s) was heated to a temperate of at least 4,000° F., a drop of water 8 was introduced and water 8 was rapidly heated to a temperature of at least 4,000° F. It was demonstrated that the polar covalent bonds were broken and photon energy was produced from the hydrogen (2) atoms and/or oxygen (1) atom.

During one experiment, two 0.020″ diameter pure tungsten wires, both 6.0″ in length, were twisted with one another used as the filament 22. Electricity was passed through the filament (tungsten wires) 22 in order to heat the wires and generate heat. The temperature of the filament (tungsten wires) 22 was regulated, via a current controllable power supply, so that the temperature did not exceed the melting temperature of tungsten (6,172° F.). The 6″ long pure tungsten wires (filament 22) were heated to white hot incandescence color approaching at temperature of about 6,000° F. A drop of water was delivered to the heated tungsten wires (filament 22) and photon energy was generated. The photon growth volume was clearly observable by the human eye. The added photon energy had a nearly elliptical shaped energy envelope which was approximately 4″ wide and 8″ high. The added energy was substantially greater in size than the size of the tungsten wires (filament 22) that provided the base heating source 4 for the drop of water 8.

Electric Arc Heating

Electrical arc 28 in air, shielded with an argon rare gas envelope 32, produces a temperature somewhere between 6,000° F. and 10,000° F. Carbon electrodes (0.125″ in diameter) were used during this experiment. The electrodes were manually induced to contact one another and initiate the arc 28, and then the electrodes were moved apart and separated from one another in order to establish and maintain the desired electrical arc 28 (see FIG. 3). The current for maintaining the electrical arc 28, before power up, was set at 105 amps AC. After the electrical arc 28 was initiated in the air, an rare gas argon envelope 32 was created and an overhead light was turned off. A drop of water 8 was delivered into the area of the electrical arc 28, and the illumination of the entire area was increased. The added photon energy envelope expanded to a very large size. Based upon this experiment, it was concluded that using the electrical arc 28, as a base heat source 4, was the most efficient source tested, as it relates to the two step process to produce photon energy in the process described herein.

Additional Base Heating Sources

Another method for the base heating would include the use of radio frequency energy, typically operating at 41 megahertz, for example, but any other FCC authorized radio frequency available for this purpose could also be utilized as a preliminary or pre-base heating source 20 for the water 8 without departing from the present invention. Again, this may be used with any other heating source that will rapidly heat (e.g., preheat) the water 8 to a temperature of at least about 4,000° F. so that the covalent bonds of the water 8 can be consistently and reliably broken and the atomic hydrogen and oxygen generally made available, from the heated water 8, along with the associated photon release of energy.

A plasma, referred to as inductively-coupled plasma (ICP) which typically utilizes argon rare gas for cooling, is still another method or technique for heating the molecules of water 8 to a temperature above 4,000° F. For example, a 1 to 5 Kilowatt radio frequency (RF) generator, operating at 27 or 41 megahertz, may be used. Such a heat source would produce an oscillating current in an induction coil that is wrapped around quartz tubes containing argon gas which is made to flow and cool a desired area or section. The induction coil creates an oscillating magnetic field. The oscillating magnet field sets up oscillating currents in the ions and electrons of the support gas. These ions and electrons then transfer the energy to the atoms in the support gas by collisions and create a very high temperature plasma flame 10 having a temperature of between 12,140.3° F. and 13,940.3° F.

Microwaves, at frequencies authorized by the FCC, may also be used as a base heat source 4, or for preheating the water 8, followed by a final heating component or method for further raising the temperature of the preheated water 8 to a temperature above 4,000° F. It is again noted that this heating process may be required in order to efficiently break the covalent bonds of the water 8 by raising the water 8 to a temperature above 4,000°, the electrons of the individual elemental atoms of the water 8 are raised to higher electron orbits in which the energy state becomes greater and, upon cooling down, the atoms release their respective photon electromagnetic energy (photonic energy) which can then be combined with and supplement the base heating source 4.

In view of the foregoing, it is readily apparent that the process of thermal decomposition of water 8 may use any known method (e.g., gas flame(s) 10, resistance heating, electrical arc heating, plasma heating, etc.) or any heating or heat up source 4 that will produce the required temperature of at least 3,992° F. (2,200° C.) so as to provide relatively efficient disassociation of the water 8.

Pre-Base Heating

According to variations of the different embodiments, a pre-heating step may also be included. During one experiment, a copper tube, which was heated from the exterior of the copper tube to eliminate flame turbulence, was utilized. The inside of the tube carried the water 8 to be delivered to the heating or heat up source 4, (i.e., by using a flame 10 to heat the copper tube to a temperature of less than 1,981° F. (less than 1,083° C.) and the tube was heated from the outside for the purpose of eliminating the turbulence of the gas flame(s) 10 and to prevent interference of the efficient combustion of the gases through the separation of the combustion gases from the water 8 being introduced to the base heat up source.

This experiment showed some promise, however, it was impossible to reach a temperature of at least 4,000° F. using a copper tube because a significant portion of the copper tube melted. Even at slightly less than less than 2,000° F. and because of the limited added photon energy results, further experiments in that direction was discontinued. However, the concept of the application appears sound. The application of a very high melting temperature ceramic tube, that would operate at a temperature greater than 4,000° F., could effectively isolate the water 8 droplet from the fast moving flame 10 when the flame 10 is applied to the interior surface of the ceramic tube. This approach would be a design improvement, for the application to heat water 8 to at least 4,000° F. Also, a tungsten tube may serve the same purpose where the flame 10 is applied to the exterior surface of the tube with water 8 delivered through the interior of the tube while being heated to a temperature of at least 4,000° F. Finally, the reverse could be employed where the flame(s) 10 is directed to the interior of the tube and the water 8 is applied to the exterior surface of a heated tube (high temperature ceramic, tungsten or other high melting temperature metal or metal alloy tube).

Additional Factors

As stated earlier, any conventional mechanism or means, or combination of such conventional mechanism or means, may be utilized for accomplishing the desired temperature to be attained, and thus to improve the system efficiency and reliably as well as consistently break the covalent bonds, and increase the amount of generated photons that is capable of being produced from the water 8 or developed by the source using heated atomic hydrogen and atomic oxygen added to the base heating source 4.

It is to be appreciated that the photonic energy, added to the base heating source 4, mainly comes from the hydrogen atoms because of the high energy photons delivered from the short end of the visible and ultraviolet spectrum, where as, the oxygen atom emits a photon at 653 nm, which has photon energy of 1.8989 eV. The photon's energy is equal to Planck's constant (h) times its frequency (1) and thus is proportional to its frequency, or inversely to its wavelength. Consequently, the energy contributed by the hydrogen atoms, at 271 nm, has a photonic energy of 4.5756 eV, or generally 2.41 times the photonic energy of the oxygen atom. Also, since there are two hydrogen atoms for every oxygen atom contained within a single dissociated molecule of water 8, the hydrogen atoms together can contribute a total photonic energy of 9.15 eV=4.5756 eV×2. This energy from the hydrogen atoms is 4.89 times the photonic energy that is generated and contributed by the oxygen atom. Based on this data, the oxygen atom only contributes approximately 20% of the added photonic energy while both of the hydrogen atoms together contribute approximately 80% of the photonic energy that is generated and added to the base heating source 4.

It must also be recognized that the wavelength of the photon produced by the atom depends on the electron shell or the orbit in which the particular electron is located, which is referred to as its quantized energy state. The free atom can only exist in discrete energy states which are associated with its orbits or shell of an electron in an hydrogen atom. Also, in the case of the hydrogen atom, its energy states allow only certain photon wavelengths when its electron jump from a higher level(s) to a lower level(s), thus producing the hydrogen spectrum. The discrete orbits or shells of the hydrogen atom are quantum numbers n=1, n=2, n=3, n=4 and n=5, with n=1 being the ground state orbit. As noted above, the higher orbits or shells represent higher energy levels. When an electron drops from a higher orbit to a lower orbit, the electron releases a photon (i.e., photonic energy) and the energy level of the photon varies based on the wavelength of the photon emitted.

At this point, an explanation is appropriate to cover the issue that pertains to the absorption of energy by the water 8 being introduced into the heating source 4 that is intended to heat the introduced water 8 to a temperature of at least 4,000° F. or higher, which must occur first. The heat up time is relatively slow when compared with a sudden discharge of a photon during the cool down time of an atom. Again, it can be logically stated, the process where the covalent bonds are broken generally starts to occur efficiently commencing at a temperature of approximately 4,000° F., the electron orbits of the atoms have been raised to a higher orbit by being heated to a high temperature. When cooled down, the atom releases a photon of energy and this photon is the energy source that occurs and can be utilized to supplement the base heating source 4. The experiments confirm that this process occurs more efficiently where the original base heating source 4 operates at a temperature of at least 4,000° F.

It has been observed that over a large number of experiments, that the greatest problem relates to introducing the water 8, to be heated to a temperature of at least 4,000° F., into the base heating source 4. Most of the introduced water 8 had a tendency to veer or jettisons off or away from the heat source, e.g., the hottest area of the heat source. One or more methods can be developed to supply a much greater percentage of the added or applied water 8 directly to the hottest zone or area of the flame 10 (i.e., the region where the two fuel sources converge and intimately mix with one another) in order to rapidly heat more added water 8 to a sufficient temperature, e.g., of at least 4,000° F., which is suitable for breaking the covalent water 8 bonds and thus converting each one of the molecules of water 8 into its elemental atomic state of hydrogen and oxygen where the released photons can then be utilized to supplement and compliment the energy of the base heating source 4, e.g., the flame 10, and thereby increase the overall efficiency of the combustion system.

Once the hydrogen and oxygen atoms cool down to a temperature below 4,000° F., those atoms are thus available to recombine with one another and again reform molecular water 8. Such reformed molecules of water 8 can then be collected and reheated and the above described process repeated. Of course, a small portion of the hydrogen atoms and the oxygen atoms may be exhausted, via within the exhaust stream, and lost directly to the atmosphere. It is to be appreciated that the amount of lost hydrogen and oxygen atoms depends upon the overall design of the associated equipment.

It is to be borne in mind that neither hydrogen nor oxygen is toxic to animal life, in a diluted form, or presents an explosion hazard or an environmental concern. With the correct design, most of the hydrogen and the oxygen can be efficiently collected and reconverted back into water 8 and then re-used within the same process. It is noted that water 8 does not wear out, when recycled, and thus can be recycled substantially indefinitely.

The added photonic energy is directly proportional to the number of atoms available from water 8, and each atom has only one photon to liberate in the Photon Production System per heating cycle at a temperature of at least 4,000° F. However, when one considers that a 0.05 ml drop of water 8, for example, contains approximately 1.67×10²³ atoms and if 100% of the molecules of water 8 were to be sufficiently heated and disassociated into its atomic constituents by heating the water to a temperature of approximately 7,000° F. (3871.1° C.), there would be a total of 1.67×10²³ photons liberated, which would be available to be added to and supplement the base heating source 4 upon those atoms cooling down. This is an extremely large number of photons to be generated from a single drop of water 8, and thus the greater the quantity of water 8 droplets added to the base heating source 4, the greater the amount of energy which is available to add to and supplement the base heating source 4. This calculation assumes that the water density is 1 g/ml, then 0.05 g divided by 18 g/mol times 6.02×10²³ molecules/mol times 3 atoms per molecule water 8 yields a value of 5.01×10²³ atoms (or available photons/energy) in a drop of water 8.

Once used in the form of added energy, the atoms eventually cool down and the water 8 (H₂O) can then be reformed (giving up additional energy) and thereafter the reformed water 8 can then be collected and reused so that the covalent bonds can again be broken and, in the heated state, upon cool down, again producing photons of energy. Such recycling is limited only by heating and reheating to a temperature of at least 4,000° F., followed by a cool down cycle between subsequent heatings, referred to as a regeneration cycle capable of infinite number of cycles.

HHO gas (Browns gas) contains only hydrogen and oxygen and is defined as a clean burning gas. Also, bottled (compressed gas) hydrogen and bottled oxygen qualify as clean burning. Browns gas (HHO) or bottled hydrogen/oxygen generally produces a combustion temperature of greater than 4,000° F. When used and combined with the added photonic energy, from the water 8 (hydrogen and oxygen), this combination results in a combined combustion process that produces a totally clean burning flame 10. On the other hand, other base heating sources 4, such as, map gas, natural gas, acetylene and other carbon based gases may produce some undesirable carbon gases and/or other undesirable byproducts. However, the carbon and/or other gases produced are greatly reduced in concentration because of the added photonic energy (is pure from a health point of view) which photon energy serves to dilute the amount of carbon gases contained in the flame 10 that is produced (Contamination/BTU produced).

It is to be appreciated that since the energy of the base heating source 4, required to break the covalent bonds, requires a minimum temperature of about 4,000° F., this process is generally a temperature dependent phenomena and mixing of energy sources may be a reasonable approach in achieving the necessary temperature to efficiently disassociate the water. For example, the use of a heater filament 22 and the use of a gas or gases (e.g., hydrogen/air and/or hydrogen/pure oxygen) for combustion would provide a two step process for preheating and then finally rapidly heating the water 8 to a temperature of at least 4,000° F.

In the event that a tungsten filament 22 is used to preheat the water 8, the combustion of hydrogen or hydrogen/oxygen from a storage tank(s), to produce a flame 10, would serve as a temperature boosting base heating source 4. This type of combined heating would be an excellent heating source. Various heating sources described above, and combinations thereof, both sequential and simultaneous in combination with one another, would be suitable for rapidly heating the water 8 to the desired temperature, and such rapid heating is desirable for an efficient process.

Another desirable feature would be to add a photon energy source (xenon arc 28 source, for example) to improve absorption of the heating source energy transferred to the molecule of water 8, being heated, and assist with breaking the covalent bonds of the molecules of water 8 more efficiently, which is, undergoing heating to a temperature of at least 4,000° F. Any combination of heating and improvement in energy absorption means that is applied to the method used will help improve the overall efficiency of the process according to the present invention.

The above discussion covers a number of base water heating sources that are currently available for this application in order to heat the water 8 to a temperature of at least 4,000° F. Many of the base heating sources 4 are clean in that they do not produce a significant amount of carbon as a byproduct, because there is no carbon or low level base products employed in the process. Also, since there is no sulfur contained within the process, they do not produce any sulfur gases or sulfur based compounds. None of the base heating source 4 described above produce any dangerous contaminates, such as, mercury or any radio active isotopes. It is to be appreciated that burning coal, for example, produces pollution that is liberated into the atmosphere and can be the cause of many health related issues and hazards. Coal not only is carbon based and produces carbon monoxide and carbon dioxide gas—which contributes to global warming—but coal also produces sulfur dioxide gas, sulfurous acid, even possibly sulfuric acid which is a chemical health hazard. Other characteristics of coal, as an energy source, are that the associated cost has doubled recently and could continue to increase in the near future. U.S. survey studies show that there is only about 100 year supply of coal available to be extracted from the ground at the present rate of consumption (an increased rate of consumption would, of course, decrease the number of years of availability of coal) before the coal supply is essentially depleted.

It is to be further understood that the photon energy that is produced by the hydrogen and oxygen atoms originates from, among other things, the breaking of covalent bonds of water molecules that are brought to temperatures of at least 4,000° F. The hydrogen and oxygen atoms act as an atomic storage means until their respective energy is released in the form of photons. More specifically, each of the atoms' energy directly or indirectly originates from the base heat up source, which is transferred to the atoms from (that is, provided by) the energy generated by the heat up source 4, or from photons emanating from other hydrogen and oxygen atoms, which originates from the base heat up source 4.

The original energy delivered from the base heat up source to the atoms, originating from the water by the above described two step method, can never exceed the total base heat up energy source. That is, the energy delivered per second times the amount of time the energy is delivered equals the maximum total energy produced by the system. The total photon energy available is always less than the total energy provided by the systems heat up source. It is to be appreciated that system energy transfer losses are always present in any energy transfer system. The laws of thermodynamics (i.e., the laws pertaining to energy transfer and energy conservation) must be complied with and/or satisfied by the two step method described herein to produce high energy photons source.

In view of the foregoing disclosure, is readily apparent that if the temperature of the base heating source 4 is at least about 7,000° F., then virtually 100% of the covalent bonds of the water are broken. It is also apparent that the second part, of the two-part process, is directly dependent upon temperature. For example, by raising the temperature of the base heating source 4 to around 21,000° F., then the hydrogen atom's electron is no longer in orbit and it is ionized. That is, at a temperature of about 21,000° F., a high temperature plasma is formed. When the temperature drops, the emitted photon has a wavelength of 94 nanometers which is the very highest energy photon possible from a hydrogen atom. It is to be further appreciated that if the hydrogen atom is raised to a temperature of 21000° F. and such hydrogen atom becomes ionized, then such hydrogen atom, upon cooling down, emits two distinct photons of two different energies from a single hydrogen atom. In the event that the hydrogen atom does not become ionized, then only a single photon is emitted from such non-ionized hydrogen atom.

It is to be appreciated that it is also possible for the base heat up sources 4 to vary greatly. For example, an electrical arc is capable of producing a temperature of approximately 43,000° F. while lasers can produce a temperature of approximately 50,000° F. According to the broadest form of the present invention, the base heating source 4 may be a single or a combination of two or more heating sources which generate a temperature ranging between approximately 4,000° F. and approximately 50,000° F. Finally, it is true that materials have maximum useful operating temperatures but design can allow one to use these high temperatures in a space, in a vacuum, under pressure, etc., and where an enclosure can be operated at a much lower operating temperature.

In the above description and appended drawings, it is to be appreciated that only the terms “consisting of” and “consisting only of” are to be construed in the limitative sense while of all other terms are to be construed as being open-ended and given the broadest possible meaning.

Since certain changes may be made in the above described Photon Production System without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I claim:

1. A high energy photon production system comprising:
a reaction vessel
a base heating source capable of generating a temperature of at least 4,000° F. within the reaction vessel; and
a source of water for supplying water to the base heating source, within the vessel, so that the water, when heated to a temperature of at least 4,000° F., at least some of the water becomes disassociated and facilitates production and release of high energy photons within the vessel.

2. The high energy photon production system according to claim 1, wherein the base heating source comprises a combustible gas flame.

3. The high energy photon production system according to claim 1 wherein the base heating source comprises first and second heating sources which arranged opposite to and facing one another, the first and the second combustible sources, during operation, interact with one another at an intersection area, and the source of water supplies the water to the intersection area.

4. The high energy photon production system according to claim 3, wherein the system includes further comprising first and second sources for supplying water which are substantially opposite to one another and positioned such that water is delivered from each one of the first and the second sources for supplying water to the intersection area.

5. The high energy photon production system according to claim 1, wherein the base heating source heats generates a temperature of at least 4,000° F. for heating the water supplied by the source of water.

6. The high energy photon production system according to claim 1, wherein the base heating source heats generates a temperature of between approximately 4,000° F. and approximately 50,000° F. for heating the water supplied by the source of water.

7. The high energy photon production system according to claim 1, wherein the base heating source comprises a tungsten filament.

8. The high energy photon production system according to claim 1, wherein the base heating source comprises an electric arc.

9. The high energy photon production system according to claim 8, wherein during operation of the system, an envelope of noble gas surrounds the electric arc.

10. A method of producing high energy photons, the method comprising the steps of
providing a reaction vessel;
generating a temperature of at least 4,000° F. within the reaction vessel via a base heating source; and
supplying water, via a source of water, to the base heating source so that the water is heated to a temperature of at least 4,000° F., and
disassociating at least some of the water to facilitate production and release of high energy photons within the vessel.

11. The method according to claim 10, further comprising the steps of breaking covalent bonds of water, via thermal decomposition, and subsequently reforming the covalent bonds during a reaction between oxygen and hydrogen atoms.

12. The method according to claim 11, further comprising the steps of
arranging first and second streams of combustible fuel to flow toward and intersect with one another;
igniting the first and the second streams of combustible fuel to combust the two streams of combustible fuel;
arranging first and second streams of water to flow toward one another such that the first and second streams of water intersect with one another approximately in a same location that the first and the second streams of combustible fuel intersect with one another.

13. The method according to claim 10, further comprising the steps of using a tungsten filament as the base heating source, and
passing current through the tungsten filament to heat the tungsten filament and disassociating the water.

14. The method according to claim 10, further comprising the step of using an electric arc as the base heating source for heating and disassociating the water.

15. The method according to claim 10, further comprising the step of using one of a combustion flame, a filament, an electric arc, a laser, and radio waves as the base heating source for heating and disassociating the water.

16. The method according to claim 10, further comprising the steps of preheating the water before supplying the water to the base heating source for producing high energy photons upon disassociation of the water.

17. The method according to claim 10, further comprising the steps of heating a portion of the water to a temperature of at least 4,000° F. within 10 milliseconds to facilitate disassociating the water.

18. The method according to claim 11, further comprising the step of heating at between 50% and 100% of the water to a temperature of between approximately 4,000° F. and approximately 50,000° F. to facilitate disassociating the water.

19. The method according to claim 11, further comprising the steps of:
arranging first and second heating sources to generate heat therebetween; and
arranging first and second streams of water to flow toward one another such that the first and second streams of water intersect with one another approximately in a central location between first and second heating sources.

20. A method of producing high energy photons, the method comprising the steps of
providing a reaction vessel;
generating a temperature of at least 4,000° F. within the reaction vessel via a base heating source;
supplying water, via a source of water, to the base heating source so that the water is heated to a temperature of at least 4,000° F., and
disassociating at least some of the water to facilitate production and release of high energy photons within the vessel;
arranging first and second heating sources to generate heat therebetween;
arranging first and second streams of water to flow toward one another such that the first and second streams of water intersect with one another approximately in a central location between first and second heating sources; and
heating at between 3% and 100% of the water to a temperature between about 4,000° F. and about 50,000° F. to facilitate disassociating the water.
